(19) United States
(12) Patent Application Publication
(10) Pub. No.: US 2024/0380462 A1
(43) Pub. Date: Nov. 14, 2024

(54) CHANNEL STATE INFORMATION (CSI) REPORT CONFIGURATION FOR TIME-DOMAIN CHANNEL PROPERTIES (TDCP)

(71) Applicant: Apple Inc., Cupertino, CA (US)

(72) Inventors: Haitong SUN, Cupertino, CA (US); Dawei ZHANG, Saratoga, CA (US); Shengshan CUI, San Diego, CA (US); Wei ZENG, Saratoga, CA (US); Chunxuan YE, San Diego, CA (US); Hong HE, San Jose, CA (US); Oghenekome OTERI, San Diego, CA (US)

(73) Assignee: Apple Inc., Cupertino, CA (US)

(21) Appl. No.: 18/656,874

(22) Filed: May 7, 2024

Related U.S. Application Data
(60) Provisional application No. 63/465,575, filed on May 11, 2023.

(51) Int. Cl. H04B 7/06; H04L 5/00; H04W 24/08

(52) U.S. Cl. CPC H04B 7/0626; H04L 5/0051; H04W 24/08

(57) ABSTRACT

Some aspects of this disclosure relate to apparatuses and methods for supporting channel state information (CSI) report configuration for measuring time-domain channel properties (TDCP) of a channel between a user equipment (UE) and a base station. The UE can receive a CSI report configuration from the base station to configure a CSI report, where the CSI report configuration includes an indicator related to a number of tracking reference signal (TRS) resource sets for measuring TDCP of the channel. A TRS resource set can include at least two symbols in a slot for CSI reference signals (CSI-RS), and the slot is repeated to form multiple slots having a periodicity. The UE can further configure the number of TRS resource sets based on a CSI resource setting associated with the CSI report configuration, monitor the configured number of TRS resource sets to perform CSI report measurements.

### RELATED APPLICATIONS

This application claims benefit of U.S. Provisional Patent Application No. 63/465,575 filed May 11, 2023, the content of which is herein incorporated by references in its entirety.

### BACKGROUND

### Field

The described aspects generally relate to channel state information (CSI) reporting.

### Related Art

A user equipment (UE) communicates with a base station, such as an evolved Node B (eNB), a next generation node B (gNB), or other base station, in a wireless communication network or system. A wireless communication system can include a fifth generation (5G) system, a New Radio (NR) system, a long term evolution (LTE) system, a combination thereof, or some other wireless systems. In addition, a wireless communication system can support a wide range of use cases such as enhanced mobile broad band (eMBB), massive machine type communications (mMTC), ultra-reliable and low-latency communications (URLLC), and enhanced vehicle to anything communications (eV2X). There are challenges in various technologies such as a NR wireless system.

### SUMMARY

Some aspects of this disclosure relate to apparatuses and methods for implementing techniques for a user equipment (UEL) or a base station to support channel state information (CSI) report configuration for time-domain channel properties (TDCP). One CSI report configuration sent from a base station can include an indication of report quality related to a number of tracking reference signal (TRS) resource sets to measure time-domain channel properties (TDCP) of a channel between the UE and the base station, where a TRS resource set can include at least two symbols in a slot, and repeated to form multiple slots having a periodicity. The implemented techniques can be applicable to many wireless systems, e.g., a wireless communication system based on 3rd Generation Partnership Project (3GPP) release 15 (Rel-15), release 16 (Rel-16), release 17 (Rel-17), release 18 (Rel-18), or beyond.

Some aspects of this disclosure relate to a UE. The UE may include a transceiver and a processor communicatively coupled to the transceiver. The transceiver can be configured to communicate with a base station. The processor can be configured to receive a CSI report configuration to configure a CSI report, where the CSI report configuration includes an indicator related to a number of tracking reference signal (TRS) resource sets for measuring time-domain channel properties (TDCP) of a channel between the UE and the base station. In some embodiments, the number of TRS resource sets includes only one TRS resource set. A TRS resource set can include at least two symbols in a slot for CSI reference signals (CSI-RS), and the slot is repeated to form multiple slots, such as up two consecutive slots, having a periodicity. The processor can further configure the number of TRS resource sets based on a CSI resource setting associated with the CSI report configuration, monitor the configured number of TRS resource sets to perform CSI report measurements. Afterwards, the processor can generate the CSI report based on the CSI report measurements, where the CSI report includes an indication of the time-domain channel properties measured based on the number of TRS resource sets. The UE can further transmit the CSI report to the base station.

In some embodiments, the CSI resource setting associated with the CSI report configuration can be included in a CSI resource configuration associated with the CSI report configuration. In some embodiments, the CSI resource setting associated with the CSI report configuration is indicated by a parameter included in the CSI report configuration. In some embodiments, the CSI resource setting associated with the CSI report configuration is indicated by an other CSI report configuration associated with and different from the CSI report configuration.

In some embodiments, the number of TRS resource sets includes a first TRS resource set, and a second TRS resource set, and the first TRS resource set and the second TRS resource set are configured with a same time domain behavior. In some embodiments, the number of TRS resource sets includes a first TRS resource set having a first periodicity, and a second TRS resource set having a second periodicity, where the second periodicity is equal to the first periodicity or a multiple of the first periodicity. In some embodiments, the number of TRS resource sets includes a first TRS resource set, and a second TRS resource set, and the first TRS resource set and the second TRS resource set are configured with one or more same quasi co-location (QCL) properties related to doppler shift, doppler spread, average delay, delay spread, Rx spatial filter or average gain. In some embodiments, the number of TRS resource sets includes a first TRS resource set, and a second TRS resource set, and the first TRS resource set and the second TRS resource set are configured with same frequency domain resources, or configured by a same CSI report configuration. In some embodiments, the CSI report and the CSI report measurements are generated by a number of CSI processing unit (CPU), and where the number of CPU is equal to the number of TRS resource sets.

A method for wireless communications by a base station with a user equipment (UE) in a wireless system is presented. The method includes generating a CSI report configuration to configure a CSI report. The CSI report configuration includes an indicator related to a number of TRS resource sets for measuring TDCP of a channel between the UE and the base station, where a TRS resource set includes at least two symbols in a slot for CSI reference signals (CSI-RS), and the slot is repeated to form multiple slots having a periodicity. The method further includes determining a CSI resource setting associated with the CSI report configuration for configuring the number of TRS resource sets; and transmitting the CSI report configuration and the CSI resource setting to the UE. The method further includes transmitting CSI reference signals (CSI-RS) over the number of TRS resource sets; and receiving the CSI report generated by the UE based on CSI report measurements performed on the CST-RS over the number of TRS resource sets.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIGS. 1A-1C illustrate an example wireless system supporting one channel state information (CSI) report configuration received from a base station for time-domain channel properties (TDCP), according to some aspects of the disclosure.

FIG. 2 illustrates a block diagram of a UE implementing support for one CSI report configuration for TDCP, according to some aspects of the disclosure.

FIGS. 3A-3B illustrate an example process performed by a UE and a base station supporting one CSI report configuration for TDCP, according to some aspects of the disclosure.

FIG. 4 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

In a wireless communication network or system, a user equipment (UE) communicates with a base station through a communication channel, where a base station can be referred to as a network node as well, such as an evolved Node B (eNB), a next generation node B (gNB), or other base station. A wireless communication system can include a fifth generation (5G) system, a New Radio (NR) system, a long term evolution (LTE) system, a combination thereof, or some other wireless systems. In a wireless system, multiple input-multiple output (MIMO) transmission can be an important technology. A UE or a base station can include an antenna array or system having a plurality of antenna panels coupled to antenna ports, where an antenna panel can include an array of antenna elements that can be located in close physical location to each other. In some examples, an antenna can be a smart antenna system, where all antenna elements are considered as pseudo-omni or quasi-sector-omni antenna elements including a phase shifter. A directional beam, such as a transmission (Tx) beam or a receiving (Rx) beam, can be formed by adjusting the phase shifter of the antenna element.

In a wireless system, channel state information (CSI) reports sent from a UE can provide the base station or the network with information about the channel conditions for a channel between the UE and the base station. A CSI report can have a time-domain behavior or attribute including one of periodic, semi-persistent, or aperiodic report. Once a periodic report configuration is configured by a Radio Resource Control (RRC) message, the CSI report can be sent periodically to the base station using the pre-allocated resource. A semi-persistent report configuration can be first configured by a RRC message, and further activated by Medium Access Control (MAC) Control Element (MAC CE) for transmission. An aperiodic report configuration can be first configured by a RRC message, and further triggered by Downlink Control Information (DCI) for one-time transmission.

A UE can measure CSI based on the CSI reference signals (CSI-RS) carried by resource sets, and generate a CSI report indicating the signal quality of the channel between the UE and the base station. A channel between the UE and the base station is typically time varying, and can have certain time coherence depending on the moving speed of the UE and the environment change rate. However, a wireless system, such as a NR wireless system, may not have exploited the time-domain channel properties (TDCP) such as correlations between CSI reports at multiple time instances for CSI reporting.

Embodiments herein may specify enhancements on a CSI reporting configuration to measure TDCP of a channel between the UE and the base station. The CSI report configuration can include an indication of report quality related to a number of tracking reference signal (TRS) resource sets for measuring TDCP. A number of TRS resource sets can be configured to perform CSI report measurements. A TRS resource set can include at least two symbols in a slot for carrying CSI reference signals (CSI-RS), and multiple slots repeated with a periodicity to measure TDCP of a channel between the UE and the base station. Due to the predetermined symbol patterns within a slot and the repetition of multiple slots, one or more TRS resource sets can be used to measure TDCP of the channel over a period of time.

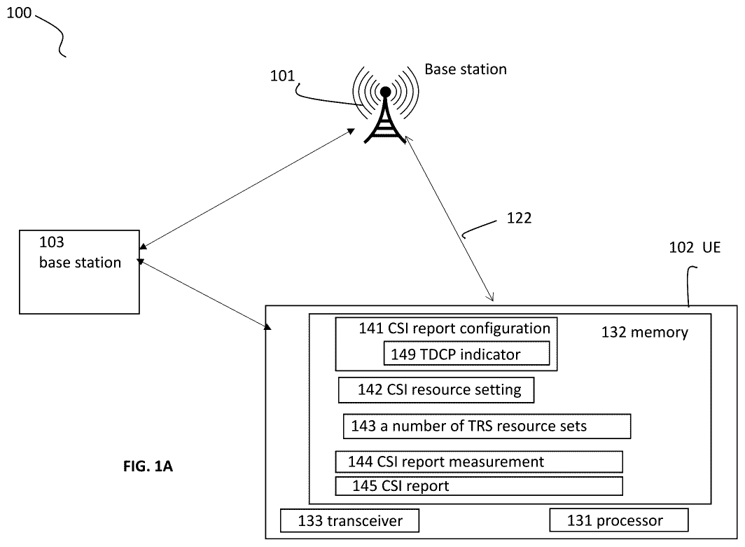

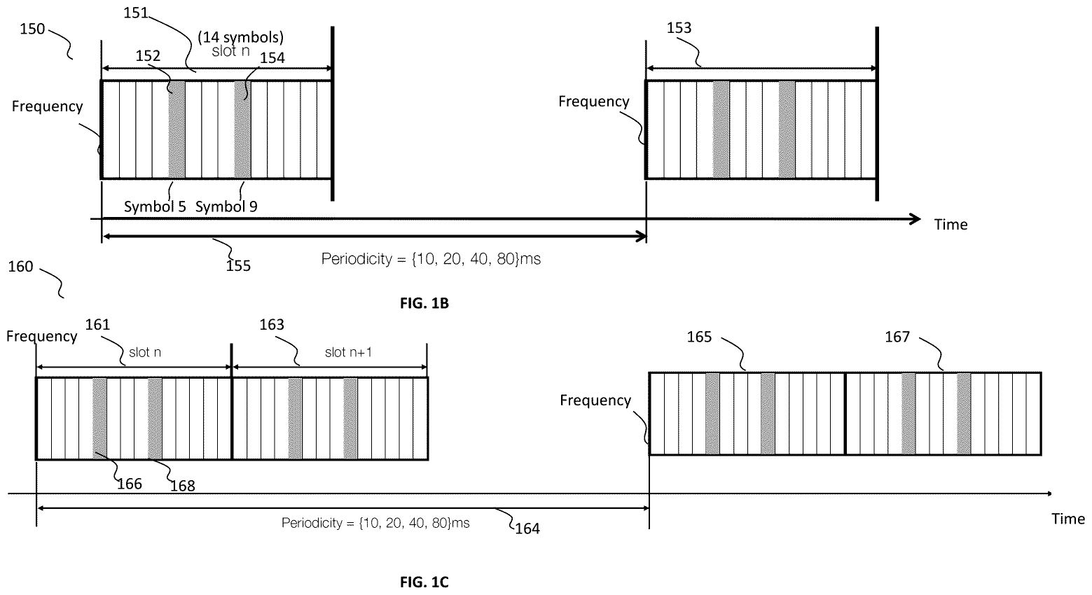

FIGS. 1A-1C illustrate an example wireless system supporting one CSI report configuration received from a base station for TDCP, according to some aspects of the disclosure. The wireless system 100 is provided for the purpose of illustration only and does not limit the disclosed aspects. As shown in FIG. 1A, system 100 can include, but is not limited to, a network node (herein referred to as abase station) 101, another base station 103, and one or more UEs, such as a UE 102. System 100 can further include additional components, not shown.

According to some aspects, a base station, such as base station 101 or base station 103, can include a network node configured to operate based on a wide variety of wireless communication techniques such as, but not limited to, techniques based on 3rd Generation Partnership Project (3GPP) standards. For example, base station 101 can include a node configured to operate using Rel-16, Rel-17, or others. The base station 101 can be a fixed station, and may also be called a base transceiver system (BTS), an access point (AP), a transmission/reception point (TRP), an evolved NodeB (eNB), a next generation node B (gNB), a network node, or some other equivalent terminology. The system 100 can operate using both licensed cellular spectrum (known as in-band communication) and unlicensed spectrum (known as out-band communication).

According to some aspects, UE 102 can be configured to operate based on a wide variety of wireless communication techniques. These techniques can include, but are not limited to, techniques based on 3GPP standards. For example, UE 102 can be configured to operate using Rel-16, Rel-17 or others. UE 102 can include, but is not limited to, a wireless communication device, a smart phone, a laptop, a desktop, a tablet, a personal assistant, a monitor, a television, a wearable device, an Internet of Things (IoTs), a vehicle's communication device, a mobile station, a subscriber station, a remote terminal, a wireless terminal, a user device, or the like.

According to some aspects, UE 102 can include a transceiver 133, a processor 131, and a memory 132 communicatively coupled to transceiver 133. Transceiver 133 can be configured to wirelessly communicate with base station 101 through a channel 122.

In some embodiments, processor 131 can receive a CSI report configuration 141 to configure a CSI report 145, where CSI report configuration 141 can include an indicator, which can be a TDCP indicator 149 related to a number of TRS resource sets 143 to measure TDCP of channel 122. Processor 131 can further configure the number of TRS resource sets 143 based on a CSI resource setting 142 associated with CSI report configuration 141. Processor 131 can monitor the configured number of TRS resource sets 143 to perform CSI report measurements 144. Afterwards, processor 131 can generate CSI report 145 based on the CSI report measurements 144, where CSI report 145 can include an indication of the TDCP measured based on the number of TRS resource sets 143. UE 102 can further transmit CSI report 145 to base station 101.

In some embodiments, CSI report 145 can include one or several pieces of information, such as Rank indicator (RI), Precoder matrix indicator (PMI), Channel-quality indicator (CQI), CSI-RS resource indicator (CRI), or other CSI information such as Layer Indicator (LI), SS/PBCH Resource Block Indicator (SSBRI). The RI can provide a recommendation on the transmission rank to use or, expressed differently, the number of layers that should preferably be used for Downlink Shared Channel (DL-SCH) transmission to UE 102. The PMI can indicate a preferred precoder to use for DL-SCH transmission, conditioned on the number of layers indicated by the RI. In embodiments, the precoder recommended by UE 102 is not explicitly signaled, but is provided as an index into a set of predefined matrices, a so-called “codebook.” The CQI can represent the highest modulation-and-coding scheme that, if used, would mean a DL-SCH transmission using the recommended RI and PMI would be received with a block-error probability of at most 10% or some other predefined percentage. The CRI can indicate the beam the UE prefers in case the UE is configured to monitor multiple beams. Together, a combination of the RI, PMI, CQI, and CRI can be included in a CSI report. Exactly what is included in a CSI report may depend on the reporting mode UE 102 is configured to be in. For example, RI and PMI do not need to be reported unless the UE 102 is in a spatial-multiplexing transmission mode.

In some embodiments, CSI report 145 can have a time-domain behavior or attribute including one of periodic, semi-persistent, or aperiodic report, which determines how often CSI report 145 is generated by UE 102 and transmitted to base station 101.

In some embodiments, CSI report configuration 141 can include various parameters such as a CSI-ReportConfig parameter, codebookConfig parameter, or a reportConfigType parameter to define a type of CSI-report, and a CSI-ResourceConfig parameter to define corresponding CSI-RS resources to be monitored to generate the CSI report. In some embodiments, for CSI report configuration 141, a reportConfigType can be periodic (P), semi-persistent (SP), or aperiodic (AP).

In some embodiments, the number of TRS resource sets 143 can include only one TRS resource set. In some embodiments, when a communication specification supports K_{TRS}≥1 TRS resource sets configured in the CSI reporting setting, such as CSI-ReportConfig parameter, for UE 102 that supports TDCP report, UE 102 may choose to support K_{TRS}=1 TRS resource set as a basic feature. It can be optional for UE 102 to support K_{TRS}>1 TRS resource set. In some embodiments, a general resource set for CSI reporting can include only one symbol in a slot. In contrast, in order to measure the time-domain channel properties (TDCP) such as correlations for CSI reporting, a TRS resource set can include multiple symbols in a slot, and the structure of the slot may be repeated multiple times with a periodicity. In this way, a TRS resource set can provide CSI-RS over multiple symbols of multiple slots to measure the channel properties over time for channel 122.

In some embodiments, as shown in FIG. 1B, as an example of TRS resource set 143, a TRS resource set 150 can include at least two symbols, a symbol 152 and a symbol 154, in a slot 151, and further include multiple slots, e.g., slot 153, repeated with a periodicity 155. A slot can be of various length. For example, for 15 kHz subcarrier spacing (SCS), each slot can be 1 millisecond (ms), while for 30 kHz SCS, each slot can be 0.5 ms. Periodicity 155 of TRS resource set 150 can be limited to {10, 20, 40, 80} ms. In some embodiments, a slot of TRS resource set 150 can include 14 symbols, and two symbols, such as symbol 152 and symbol 154, can be separated with 3-symbol gap, as shown in FIG. 1B. In some embodiments, symbol 152 and symbol 154 can carry the same reference signal, e.g., a 1 port CSI-RS. The time domain locations of the two CSI-RS resource symbols in a slot of a TRS resource set can be symbols {4, 8}, {5, 9}, {6, 10} for frequency range 1 or frequency range 2. In FIG. 1B, the time domain location is {4, 8}. In addition, for frequency range 2, the time domain locations of the two CSI-RS resource symbols in a slot of a TRS resource set can be symbols {0, 4}, {1, 5}, {2, 6}, {3,7}, {7, 11}, {8, 12}, or {9, 13}.

In some embodiments, TRS resource set 150 can be a NZP-CSI-RS-ResourceSet with the parameter “trs-Info” set to ‘true,’ as shown below in detail:
NZP-CSI-RS-ResourceSet::=SEQUENCE {
nzp-CSI-ResourceSetID NZP-CSI-RS-ResourceSetID,
nzp-CSI-Resources SEQUENCE (SIZE (1 . . . maxNrofNZP-CSI-RS-ResourcesPerSet)) OF NZP-CSI-RS-Resourced ID,
repetition ENUMERATED {on, off} OPTIONAL, -Need S
aperiodTriggeringOffsetINTEGER (0 . . . 6) OPTIONAL, -Need S
trs-Info ENUMERATED {true}| OPTIONAL, -Need R

In some embodiments, as shown in FIG. 1C, as an example of TRS resource set 143, a TRS resource set 160 can include two consecutive slots, slot 161, slot 163, which can form an instance of TRS resource set 160. In addition, TRS resource set 160 includes multiple instances repeated with a periodicity 164, such as a second instance including slot 165 and slot 167. For example, periodicity 164 can have a value chosen from {10, 20, 40, 80} ms. Each slot can include at least two symbols (166, 168) as CSI-RS resources. Accordingly, there are 4 symbols used as CSI-RS resources for the two adjacent slots, slot 161, slot 163 in one period of TRS resource set 160.

In some embodiments, the number of TRS resource sets 143, such as TRS resource set 150 or TRS resource set 160, can be configured by CSI resource setting 142 associated with CSI report configuration 141. In some embodiments, CSI resource setting 142 can be included in a CSI resource configuration, such as indicated by a CSI-ResourceConfig parameter associated with the CSI report configuration. When there are more than one TRS resource sets, K_{TRS}≥1, where each TRS resource set is a NZP-CSI-RS-Resource set, all the K_{TRS} TRS resource sets can be configured in a same CSI resource configuration parameter, e.g., CSI-ResourceConfig. Such a parameter CSI-ResourceConfig can be related to the telecommunication standard TS38.214. In some embodiments, the time domain behavior of the CSI-RS resources within CSI resource setting 142 can be indicated by the higher layer parameter resourceType and can be set to aperiodic, periodic, or semi-persistent in CSI resource setting 142. For periodic and semi-persistent CSI resource setting 142, when the number of TRS resource sets 143 is configured as NZP-CSI-RS-ResourceSet with “trs-Info” set to ‘true’, 1 or more than 1 TRS resource sets can be configured as follows:
CSI-ResourceConfig::=SEQUENCE {
   csi-ResourceConfigID CSI-ResouceConfigId,
   csi-RS-ResourceSetList CHOICE {
      nzp-CSI-RS-SSB SEQUENCE {
      nzp-CSI-RS-ResourceSetList SEQUENCE (SIZE (1 . . . maxNrofNZP-CSI-RS-ResourceSetsPerConfig)) OF NZP-CSI-RS-ResourceSetID

In some embodiments, CSI resource setting 142 associated with CSI report configuration 141 can be indicated by a parameter included in CSI report configuration 141. When there are K_{TTS}≥1 TRS resource sets, a parameter resourcesForChannelMeasurement can be configured in the same CSI-ReportConfig as follows.
CSI-ReportConfig::=SEQUENCE {
   reportConfigId CSI-ReportConfigId,
   carrier ServCellIndex OPTIONAL, -Need S
   resourcesForChannelMeasurement CSI-ResourceConfigId,
   resourcesForChannelMeasurement-r18 SEQUENCE (SIZE (1 . . . maxNrofCSI-ResourceConfig)) OF CSI-ResourceConfigId,
esi-IM-ResourcesForInterference CSI-ResourceConfigId OPTIONAL, -Need R.

In some embodiments, network is only expected to configure one of the resourcesForChannelMeasurement and resourcesForChannelMeasurement-r18 parameters shown above. When more than one resourcesForChannelMeasurement is configured in the same CSI-ReportConfig, all resourcesForChannelMeasurement are expected to be configured with the same Bandwidth Part (BWP) ID (bwp-Id).

In some embodiments, CSI resource setting 142 associated with CSI report configuration 141 can be indicated by an other CSI report configuration associated with and different from the CSI report configuration, such as configured by CSI-AssociatedReportConfigInfo. In some embodiments, there can be K_{TRS}≥1 resourcesForChannel configured in the same CSI-AssociatedReportConfigInfo, as shown below.

```
CSI-AssociatedReportConfigInfo ::= SEQUENCE {
  reportConfigId CSI-ReportConfigId,
  resourcesForChannel CHOICE {
  nzp-CSI-RS SEQUENCE {
  resourceSet INTEGER (1..maxNrofNZP-CSI-RS-ResourceSetsPerConfig),
  qcl-info SEQUENCE (SIZE(1..maxNrofAP-CSI-RS-ResourcesPerSet)) OF TCI-
StateId OPTIONAL -- Cond Aperiodic
  },
  csi-SSB-ResourceSet INTEGER (1..maxNrofCSI-SSB-ResourceSetsPerConfig)
  },
  resourcesForChannel-r18 SEQUENCE {
  resourceSet-r18 SEQUENCE (SIZE (1..maxNrofCSI-ResourceConfig)) OF
INTEGER (1..maxNrofNZP-CSI-RS-ResourceSetsPerConfig),
  qcl-info SEQUENCE (SIZE (1..maxNrofCSI-ResourceConfig)) OF TCI-StateId --
Cond Aperiodic
  }
```

csi-IM-ResourcesForInterference INTEGER(1 . . . maxNrofCSI-IM-ResourceSetsPerConfig) OPTIONAL, -Cond CSI-IM-ForInterference.

In some embodiments, the network is only expected to configure one of the resourcesForChannel and resourcesForChannel-r18. Each TCI-StateId applies to all the NZP-CSI-RS-Resources in the corresponding indicated NZP-CSI-RS-ResourceSet in resourcesForChannel-r18.

In some embodiments, the number of TRS resource sets 143 can include a first TRS resource set, and a second TRS resource set, and the first TRS resource set and the second TRS resource set are configured with a same time domain behavior. In some embodiments, the number of TRS resource sets includes a first TRS resource set having a first periodicity, and a second TRS resource set having a second periodicity, where the second periodicity is equal to the first periodicity or a multiple of the first periodicity. In some embodiments, the number of TRS resource sets includes a first TRS resource set, and a second TRS resource set, and the first TRS resource set and the second TRS resource set are configured with one or more same quasi co-location (QCL) properties related to doppler shift, doppler spread, average delay, delay spread, Rx spatial filter or average gain. In some embodiments, the number of TRS resource sets includes a first TRS resource set, and a second TRS resource set, and the first TRS resource set and the second TRS resource set are configured with same frequency domain resources, or configured by a same CSI report configuration. In some embodiments, the CSI report and the CSI report measurements are generated by a number of CSI processing unit (CPU), and where the number of CPU is equal to the number of TRS resource sets.

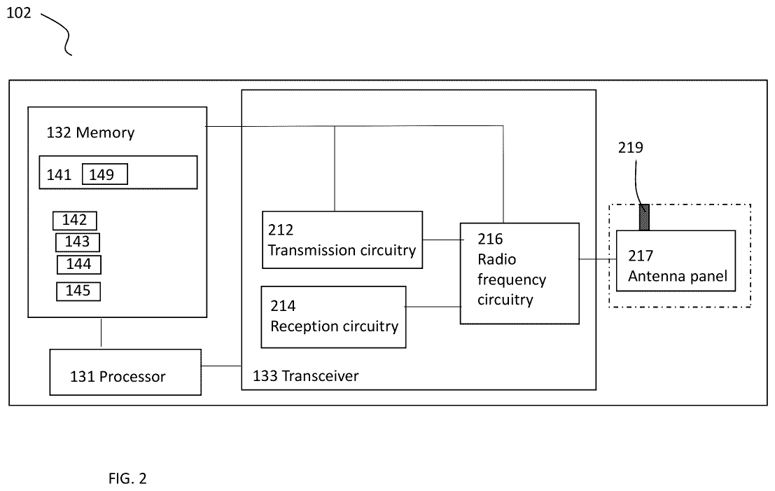

According to some aspects, UE 102 can be implemented according to a block diagram as illustrated in FIG. 2.

Referring to FIG. 2, UE 102 can have antenna system including one or more antenna elements 219 of antenna panel 217 to form various beams coupled to transceiver 133 and controlled by processor 131. Transceiver 133 and antenna system can enable wireless communication in a wireless network, such as wireless system 100, including wireless communication with base station 101. In detail, transceiver 133 can include radio frequency (RF) circuitry 216, transmission circuitry 212, and reception circuitry 214 to enable wireless communication with other UEs and/or a base station as discussed for wireless system 100. RF circuitry 216 can include multiple parallel RF chains for one or more of transmit or receive functions, each connected to one or more antenna elements of the antenna panel. In addition, processor 131 can be communicatively coupled to memory 132, which are further coupled to the transceiver 133. Various data can be stored in memory 132. In some examples, memory 132 can store CSI report configuration 141 including TDCP indicator 149, CSI resource setting 142, the number of TRS resource sets 143, CSI report measurements 144, and CSI report 145.

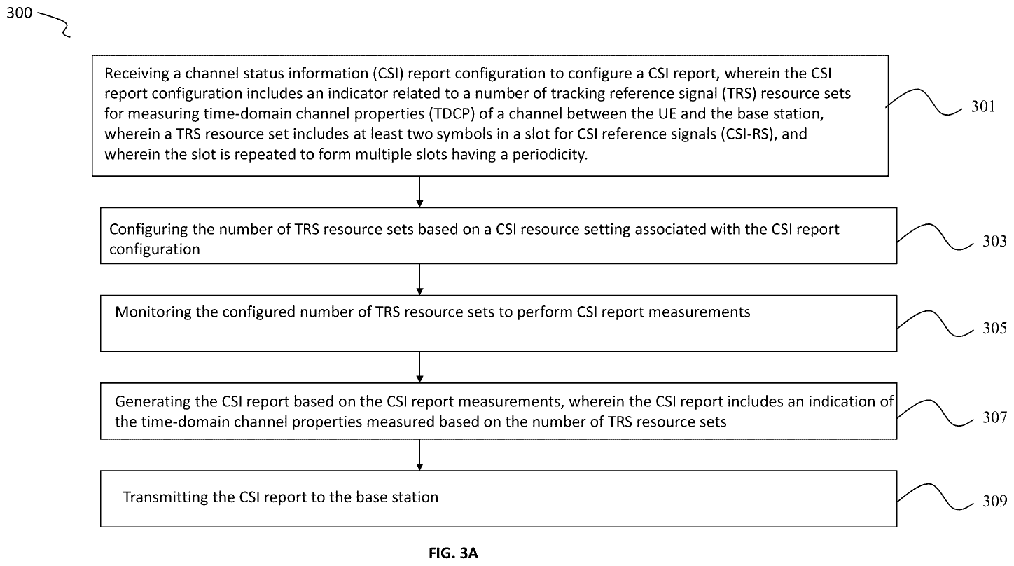

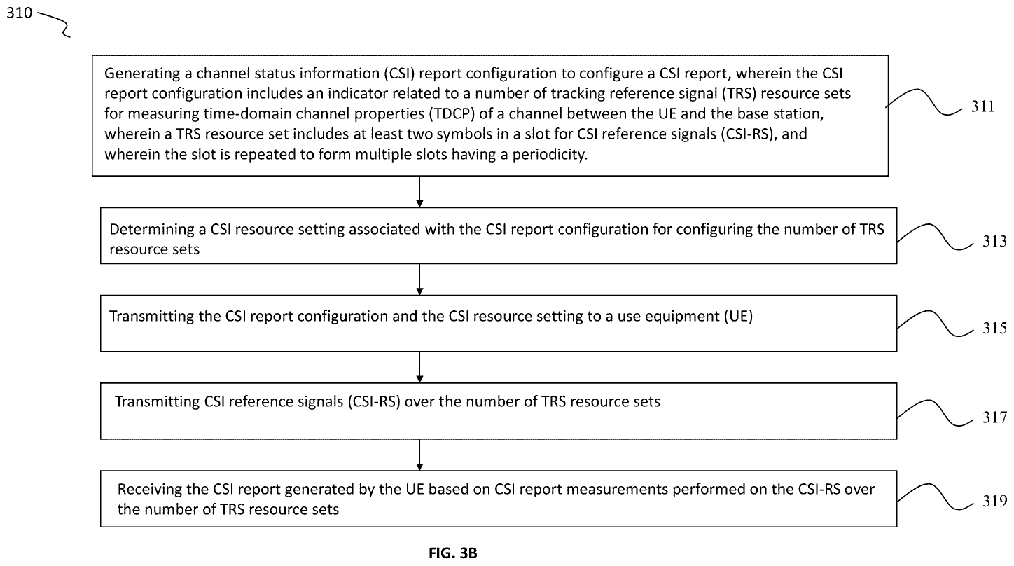

In some embodiments, memory 132 can store instructions, that when executed by processor 131 perform or cause to perform operations described herein, e.g., operations to support CSI report configuration for TDCP. Alternatively, processor 131 can be “hard-coded” to perform the operations described herein. In some embodiments, processor 131 can be configured to perform operations described for FIGS. 3A-3B.

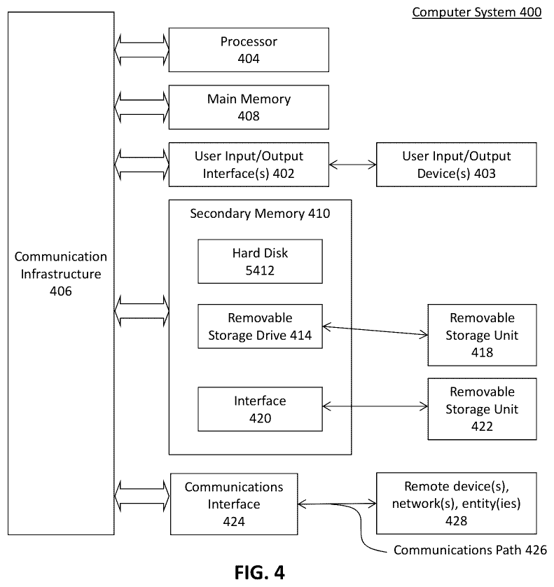

FIG. 3A illustrates an example process 300 performed by UE 102 supporting CSI report configuration for TDCP, according to some aspects of the disclosure. Process 300 can be performed by UE 102, which may be implemented as shown in FIG. 2. Process 300 may also be performed by a computer system 400 of FIG. 4. Process 300 is not limited to the specific aspects depicted in those figures and other systems may be used to perform the method as will be understood by those skilled in the art. It is to be appreciated that not all operations may be needed, and the operations may not be performed in the same order as shown in process 300.

At 301, processor 131 of UE 102 can receive CSI report configuration 141 to configure CSI report 145. CSI report configuration 141 includes an indication of report quality such as TDCP indicator 149 that is related to the number of TRS resource sets 143 to measure TDCP of channel 122 between UE 102 and base station 101. The number of TRS resource sets 143 can include at least two symbols (e.g., 152, 154) in a slot (e.g., 151) for CSI-RS, and multiple slots repeated with a periodicity, as shown in FIG. 1B and FIG. 1C.

At 303, processor 131 of UE 102 can configure the number of TRS resource sets 143 based on CSI resource setting 142 associated with CSI report configuration 141. In some embodiments, there can be multiple TRS resource sets configured. As illustrated in the descriptions below, various limitations and restrictions can be applied to multiple TRS resource sets of the number of TRS resource sets 143 to increase the coherence between the symbols and slots of the number of TRS resource sets 143. In some embodiments, the limitations and restrictions can include time domain behavior, periodicity, relative slot offset, QCL properties, Physical Resource Block (PRB), and more. Such coherence can improve the consistency of the CSI-RS being transferred, leading to improved accuracy of the measurements for TDCP of channel 122.

In some embodiments, UE 102 can support K_{TRS}≥1 TRS resource sets configured in the CSI reporting setting, which can be CSI report configuration 141. TRS resource sets can be configured by setting a parameter ReportQuantity to be “tdcp” or “TDCP” as TDCP indicator 149. In some embodiments, multiple (K_{TRS}>1) TRS resource sets are configured with the same time domain behavior. For example, K_{TRS} TRS resource sets are either all periodic, or all aperiodic, or all semi-persistent if semi-persistent is supported by the specification. In some embodiments, K_{TRS} TRS resource sets can be configured with different time domain behavior. For example, some TRS resource set can be configured as periodic, while others can be configured with aperiodic.

In some embodiments, in terms of the periodicity of the TRS resources, such as NZP-CSI-RS-Resources, all the TRS resource sets in the corresponding CSI-ResourceConfig or CSI-ReportConfig can have the same periodicity. Additionally and alternatively, the periodicity of different TRS resource sets can be integer multiple of each other.

In some embodiments, when network configures K_{TRS}≥1 TRS resource sets in the same CSI reporting setting, which can be CSI report configuration 141, the corresponding CSI-ResourceConfig can be configured as either semi-persistent or periodic. In terms of the slot offset of different TRS resource sets, such as NZP-CSI-RS-ResourceSets, with reference to the earliest TRS resource set, the relative slot offset of the other TRS resource sets can only take limited value from a subset. For example, the slot offset can be selected from {2, 3, 4, 5, 6, 10} slots.

In some embodiments, the network can configure multiple (K_{TRS}>1) TRS resource sets in the same CSI reporting setting, which can be CSI report configuration 141. If the corresponding CSI-ResourceConfig is configured as aperiodic, for the parameter aperiodicTriggeringOffset of different TRS resource sets, e.g., NZP-CSI-RS-ResourceSets, with reference to the earliest TRS resource set, the relative aperiodicTriggeringOffset of the other TRS resource sets can only take limited value from a subset, such as {2, 3, 4, 5, 6, 101 slots.

In some embodiments, the network can configure multiple (K_{TRS}>1) TRS resource sets in the same CSI reporting setting, which can be CSI report configuration 141. All the TRS resources in all the TRS resource sets can have the same QCL properties such as doppler shift, doppler spread, average delay, delay spread, average gain, or other QCL properties. For an aperiodic CSI report, only single TCI-StateId may be configured per CSI-AssociatedReportConfigInfo.

In some embodiments, the network can configure multiple (K_{TRS}>1) TRS resource sets in the same CSI reporting setting, which can be CSI report configuration 141. All the TRS resources in all the TRS resource sets can be configured with the same frequency domain resources such as Physical Resource Block (PRB), or resource elements (RE) within the PRBs. For example, the frequency domain resources for a first TRS resource set and the frequency domain resources for a second TRS resource set include a same physical resource block (PRB) or a same resource element within a PRB.

In some embodiments, the network can configure multiple (K_{TRS}>1) TRS resource sets in the same CSI reporting setting, which can be CSI report configuration 141. All the TRS resource sets can be configured with the same number of slots, i.e., either all 2 slot TRS resource set or 1 slot TRS resource set.

In some embodiments, the network can configure multiple (K_{TRS}>1) TRS resource sets in the same CSI reporting setting, which can be CSI report configuration 141. For all the TRS resource sets associated with the same CSI-ReportConfig, the same symbol location can be used in every slot. The time-domain locations of the two CSI-RS resources in a slot, or of the four CSI-RS resources in two consecutive slots (which are the same across two consecutive slots), as defined by higher layer parameter CSI-RS-resourceMapping, is given by one of lϵ{4,8}, lϵ{5,9}, or lϵ{6,10} for frequency range 1 and frequency range 2, or lϵ{0,4}, lϵ{1,5}, lϵ{2,6}, lϵ{3,7}, lϵ{7,11}, lϵ{8,12} or lϵ{9,13} for frequency range 2.

At 305, processor 131 of UE 102 can monitor the configured number of TRS resource sets 143 to perform CSI report measurements 144.

At 307, processor 131 of UE 102 can generate CSI report 145 based on CSI report measurements 144, where CSI report 145 can include an indication of the time-domain channel properties measured based on the number of TRS resource sets. For example, CSI report measurements 144 can be performed on multiple symbols of a slot where the symbol is repeated to form multiple slots with a periodicity, as shown in FIGS. 1B-1C. When a first CSI report measurement is performed for slot 151, and a second CSI report measurement is performed for slot 153, the two CSI report measurements can show a correlation over time, which can be an indication of the time-domain channel properties. Similarly, when a first CSI report measurement is performed for slot 161, a second CSI report measurement is performed for slot 163, a third CSI report measurement is performed for slot 165, a fourth CSI report measurement is performed for slot 167, the four CSI report measurements can show a correlation over time, which can be an indication of the time-domain channel properties.

At 309, processor 131 of UE 102 can transmit CSI report 145 to base station 101.

In some embodiments, the network can configure multiple (K_{TRS}>1) TRS resource sets in the same CSI reporting setting, according to CSI report configuration 141. UE 102 can report to base station 101 the number of CSI Process Unit (CPU) that can be used to perform operations for CSI report measurements 144, generating CSI report 145, and transmitting CSI report 145. In some embodiments, UE 102 can use a same number of CPUs as the number of TRS resource sets. In some embodiments, UE 102 can use only one CPU to perform the related operations, or use a total number of TRS resources in all TRS resource sets.

In some embodiments, the network can configure multiple (K_{TRS}>1) TRS resource sets in the same CSI reporting setting, which can be CSI report configuration 141. UE 102 can have a low latency in performing operations for CSI report measurements 144, generating CSI report 145, and transmitting CSI report 145. For example, the latency can be defined similarly to Table 5.4-1 in TS38.214, as shown below, where latency is defined by the parameter Z₁ or Z′₁.

TABLE 5.4-1
CSI computation delay requirement 1

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

In some embodiments, the network can configure multiple (K_{TRS}>1) TRS resource sets in the same CSI reporting setting, which can be CSI report configuration 141. UE 102 can have a low latency in performing operations for CSI report measurements 144, generating CSI report 145, and transmitting CSI report 145. For example, the latency can be defined similarly to Table 5.4-1 in TS38.214, as shown below, where delays are measured by the number of symbols represented by Z₁ or Z′₁, Z₂ or Z′₂, Z₃ or Z′₃. In some embodiments, in FR2 or when QCL-TypeD is configured for the TRS resources, Z₃ is used. In some embodiments, network can configure 2 slot TRS resources for each TRS resource set.

TABLE 5.4-2
CSI computation delay requirement 2

| | Z1 symbols | | Z1 symbols | | Z1 symbols | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min (44, X₂ + KB₁) | X₂ |
| 3 | 97 | 85 | 152 | 140 | min (97, X₂ + KB₂) | X₃ |
| 5 | 386 | 340 | 608 | 560 | $min ( 368 , X 5 + KB 3 )$ | X5 |
| 6 | 776 | 680 | 1216 | 1120 | $min ( 776 , X 6 + KB 4 )$ | X6 |

FIG. 3B illustrates an example process 310 performed by base station 101 supporting CSI report configuration for TDCP, according to some aspects of the disclosure. Process 310 can be performed by UE 102, which may be implemented as shown in FIG. 2. Process 300 may also be performed by a computer system 400 of FIG. 4. Process 300 is not limited to the specific aspects depicted in those figures and other systems may be used to perform the method as will be understood by those skilled in the art. It is to be appreciated that not all operations may be needed, and the operations may not be performed in the same order as shown in process 300.

At 311, base station 101 can generate CSI report configuration 14 to configure CSI report 145. CSI report configuration 141 includes an indicator, e.g., TDCP indicator 149, related to the number of TRS resource sets 143 for measuring TDCP of channel 122 between UE 102 and base station 101. A TRS resource set can include at least two symbols in a slot for CSI-RS, wherein the slot is repeated to form multiple slots having a periodicity, as shown in FIGS. 1B-1C.

At 313, base station 101 can determine CSI resource setting 142 associated with CSI report configuration 141 for configuring the number of TRS resource sets 143.

At 315, base station 101 can transmit CSI report configuration 141 and CSI resource setting 143 to UE 102.

At 317, base station 101 can transmit CSI-RS over the number of TRS resource sets 143.

At 319, base station 101 can receive CSI report 145 generated by UE 102 based on CSI report measurements performed on the CSI-RS over the number of TRS resource sets 143.

Various aspects can be implemented, for example, using one or more computer systems, such as computer system 400 shown in FIG. 4. Computer system 400 can be any computer capable of performing the functions described herein such as UE 102 or base station 101 in FIG. 1, for operations described for processor 131 or process 300. Computer system 400 includes one or more processors (also called central processing units, or CPUs), such as a processor 404. Processor 404 is connected to a communication infrastructure 406 (e.g., a bus). Computer system 400 also includes user input/output device(s) 403, such as monitors, keyboards, pointing devices, etc., that communicate with communication infrastructure 406 through user input/output interface(s) 402. Computer system 400 also includes a main or primary memory 408, such as random access memory (RAM). Main memory 408 may include one or more levels of cache. Main memory 408 has stored therein control logic (e.g., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to some aspects, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 408, the removable storage unit 418, the removable storage unit 422 can store instructions that, when executed by processor 404, cause processor 404 to perform operations for a UE, UE 102 or base station 101 in in FIG. 1, for operations described for processor 131 or process 300.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 400, main memory 408, secondary memory 410 and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 4. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a UE, base station, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to enable wireless communication with a base station in a wireless system; and
a processor communicatively coupled to the transceiver and configured to:
receive a channel status information (CSI) report configuration to configure a CSI report, wherein the CSI report configuration includes an indicator related to a number of tracking reference signal (TRS) resource sets for measuring time-domain channel properties (TDCP) of a channel between the UE and the base station, wherein a TRS resource set includes at least two symbols in a slot for CSI reference signals (CSI-RS), and wherein the slot is repeated to form multiple slots having a periodicity;
configure the number of TRS resource sets based on a CSI resource setting associated with the CSI report configuration;
monitor the configured number of TRS resource sets to perform CSI report measurements;
generate the CSI report based on the CSI report measurements, wherein the CSI report includes an indication of the time-domain channel properties measured based on the number of TRS resource sets; and
transmit the CSI report to the base station.

2. The UE of claim 1, wherein the number of TRS resource sets includes only one TRS resource set.

3. The UE of claim 1, wherein the CSI resource setting associated with the CSI report configuration is included in a CSI resource configuration associated with the CSI report configuration.

4. The UE of claim 1, wherein the CSI resource setting associated with the CSI report configuration is indicated by a parameter included in the CSI report configuration.

5. The UE of claim 1, wherein the CSI resource setting associated with the CSI report configuration is indicated by an other CSI report configuration associated with and different from the CSI report configuration.

6. The UE of claim 1, wherein the number of TRS resource sets includes a first TRS resource set and a second TRS resource set, wherein the first TRS resource set and the second TRS resource set are configured for the CSI report to have a same time domain behavior including a periodic CSI report, a semi-persistent CSI report, or an aperiodic CSI report.

7. The UE of claim 1, wherein the number of TRS resource sets includes a first TRS resource set having a first periodicity and a second TRS resource set having a second periodicity, wherein the second periodicity is equal to the first periodicity or a multiple of the first periodicity.

8. The UE of claim 1, wherein the number of TRS resource sets includes a first TRS resource set and a second TRS resource set, wherein the first TRS resource set and the second TRS resource set are configured with one or more same quasi co-location (QCL) properties related to doppler shift, doppler spread, average delay, delay spread, receiving (Rx) spatial filter, or average gain.

9. The UE of claim 1, wherein the number of TRS resource sets includes a first TRS resource set and a second TRS resource set, wherein the first TRS resource set and the second TRS resource set are configured with same frequency domain resources.

10. The UE of claim 9, wherein the frequency domain resources for the first TRS resource set and the frequency domain resources for the second TRS resource set include a same physical resource block (PRB) or a same resource element within a PRB.

11. The UE of claim 1, wherein the CSI report and the CSI report measurements are generated by a number of CSI processing units (CPUs), and wherein the number of CPUs is equal to the number of TRS resource sets.

12. A method for wireless communications by a base station with a user equipment (UE) in a wireless system, comprising:
generating a Channel Status Information (CSI) report configuration to configure a CSI report, wherein the CSI report configuration includes an indicator related to a number of tracking reference signal (TRS) resource sets for measuring time-domain channel properties (TDCP) of a channel between the UE and the base station, wherein a TRS resource set includes at least two symbols in a slot for CSI reference signals (CSI-RS), wherein the slot is repeated to form multiple slots having a periodicity;
determining a CSI resource setting associated with the CSI report configuration for configuring the number of TRS resource sets;
transmitting the CSI report configuration and the CSI resource setting to the UE;
transmitting CSI reference signals (CSI-RS) over the number of TRS resource sets; and
receiving the CSI report generated by the UE based on CSI report measurements performed on the CSI-RS over the number of TRS resource sets.

13. The method of claim 12, wherein each TRS resource set in the number of TRS resource sets is a NZP-CSI-RS-Resource set configured by a same configuration parameter.

14. The method of claim 12, wherein the CSI resource setting associated with the CSI report configuration is indicated by a parameter included in the CSI report configuration.

15. The method of claim 12, wherein the CSI resource setting associated with the CSI report configuration is indicated by an other CSI report configuration associated with and different from the CSI report configuration.

16. The method of claim 12, wherein the number of TRS resource sets includes a first TRS resource set and a second TRS resource set, wherein the first TRS resource set and the second TRS resource set are configured with a same time domain behavior.

17. A non-transitory computer-readable medium storing instructions that, when executed by a processor of a base station, cause the base station to perform operations, the operations comprising:
generating a Channel Status Information (CSI) report configuration to configure a CSI report, wherein the CSI report configuration includes an indicator related to a number of tracking reference signal (TRS) resource sets for measuring time-domain channel properties (TDCP) of a channel between the UE and the base station, wherein a TRS resource set includes at least two symbols in a slot for CSI reference signals (CSI-RS), wherein the slot is repeated to form multiple slots having a periodicity;
determining a CSI resource setting associated with the CSI report configuration for configuring the number of TRS resource sets;
transmitting the CSI report configuration and the CSI resource setting to the UE;
transmitting CSI reference signals (CSI-RS) over the number of TRS resource sets; and
receiving the CSI report generated by the UE based on CSI report measurements performed on the CSI-RS over the number of TRS resource sets.

18. The non-transitory computer-readable medium of claim 17, wherein the CSI resource setting associated with the CSI report configuration is included in a CSI resource configuration associated with the CSI report configuration.

19. The non-transitory computer-readable medium of claim 17, wherein the CSI resource setting associated with the CSI report configuration is indicated by a parameter included in the CSI report configuration.

20. The non-transitory computer-readable medium of claim 17, wherein the CSI resource setting associated with the CSI report configuration is indicated by an other CSI report configuration associated with and different from the CSI report configuration.
